(19) United States
(12) Patent Application Publication
(10) Pub. No.: US 2024/0261803 A1
(43) Pub. Date: Aug. 8, 2024

(54) Apparatus and Method for Enhancing the Quality of a Fluid

(71) Applicant: Noetix Pharma LLC, Bethesda, MD (US)

(72) Inventor: Arnold L. Newman, Bethesda, MD (US)

(73) Assignee: Noetix Pharma LLC, Bethesda, MD (US)

(21) Appl. No.: 18/567,186

(22) PCT Filed: May 16, 2022
(86) PCT No.: PCT/US2022/029363

§ 371 Date: Dec. 5, 2023

Related U.S. Application Data
(60) Provisional application No. 63/210,579, filed on Jun. 15, 2021.

(51) Int. Cl. B04C 3/00; B01D 45/16

(52) U.S. Cl. CPC B04C 3/00; B01D 45/16; B04C 2003/006

(57) ABSTRACT

An apparatus for enhancing the quality of a fluid, containing a plurality of vortex forming elements, each containing: a) a fixed swirler for imparting a centrifugal force on a moving fluid stream; and b) a porous matrix for capturing particles contained within said moving fluid stream and/or adding substances contained in said porous matrix to said moving fluid stream, wherein the vortex forming elements are disposed within the porous matrix.

### BACKGROUND OF THE INVENTION

There is a need for an apparatus that enhances the quality of a fluid. Enhancing the quality of a fluid can mean either removing something from the fluid or adding something to the fluid. Thus, there is a need for an apparatus and method that enhances a fluid by efficiently separating impurities such as solid particles and gases from fluids. There is also a need for an apparatus and method that enhances a fluid by adding a substance or substances to the fluid. Further, there is a need for a fluid quality enhancing apparatus and method that more efficiently separates substances with different physical and/or chemical properties, for example, hydrophobic fluids from hydrophilic fluids. Additionally, there is a need for an apparatus that extracts substances more efficiently from a porous matrix and/or adds substances more efficiently to a porous matrix thus providing for more efficient chemical and/or physical interaction between a porous matrix and a fluid.

Global climate change is an existential threat that has resulted from the long-term accumulation of pollutants, including greenhouse gases, in the environment. Pollution of the oceans, lakes, rivers, and ground water both directly and indirectly contributes to climate change as well as threatening the health and safety of populations. Technology must be transformed greatly to reduce the release of pollutants and minimize energy use. Technology should also be improved to protect people from harmful substances such as contaminants in water, food, and pharmaceuticals.

Filters and extraction columns are critical components in the development and production of vaccines. Lack of a sufficient supply of efficient filtration and extraction devices has been one factor limiting the supply of vaccine precursors, such as reagents, and vaccines themselves during the COVID pandemic.

Filters and other separation and sequestration devices are ubiquitous across technology and are vital in removing pollutants and undesirable particulates in many processes. However, because they inherently resist fluent flow, they also dissipate energy and produce heat. Improving filtration efficiency will more effectively limit pollution and diminish energy consumption and reduce heat output.

An efficient device for filtering, separating, sequestering, or otherwise enhancing a fluid would remove, separate or sequester targeted substances completely or to the extent that any residual content of the targeted substance in a fluid is of insufficient quantity to cause downstream harm. There is also a need for an efficient fluid enhancing device that adds a substance or substances to a fluid.

Efficient separation or sequestration devices and devices that add substances to a fluid would achieve the above by also providing an increased average path length for substances of interest while minimizing resistance to fluid flow.

A need exists for a means of more effectively filtering, separating, sequestering, adding a substance to a fluid, or otherwise enhancing a fluid by efficiently increasing the likelihood of an interaction between a fluid and/or its contents with a porous matrix while also minimizing resistance to fluid flow.

### SUMMARY OF THE INVENTION

The present invention provides an efficient apparatus for filtering, separating, or sequestering particulate matter in a fluid while reducing flow resistance through a porous medium.

The present invention further provides a means of inhibiting the spread of pollutants, particulates, pathogenic agents and other undesirable substances in a liquid.

The present invention also provides a means for increasing the likelihood of a physical and/or chemical interaction between a porous material and a fluid moving therethrough.

The present invention further reduces the impure content of liquids such as water and thereby improves the health of humans and animals.

The present invention can enhance the content of a fluid by providing a means by which the fluid can efficiently extract or otherwise have substances added to it from the porous matrix.

Accordingly, these advantages and others are provided by a filtration, separation, sequestration and/or extraction apparatus for improving the quality of fluids such as water, containing a plurality of vortex forming elements each vortex element containing: 1) a fixed swirler for imparting a centrifugal force on a moving fluent stream, and 2) a porous matrix for capturing, separating, sequestering, filtering, and/or extracting particles or substances, thereby enhancing said fluent stream, wherein said vortex forming elements are disposed within said porous matrix.

### BRIEF DESCRIPTION OF THE DRAWINGS

FIG. 1 is a three-dimensional drawing of a single vortex forming element shown as a helical blade within a vortex port and associated porous material and which illustrates a simplified operation of the present invention.

FIG. 2 is a three-dimensional drawing of a portion of a vortex array comprising a plurality of vortex ports embedded within an associated porous material.

FIG. 3A is a three-dimensional drawing of a portion of a vortex array comprising a plurality of vortex forming blades disposed directly within, and in intimate contact with, a porous matrix. FIG. 3B is a three-dimensional drawing of a portion of a vortex array comprising a plurality of vortex forming blades disposed directly and intimately within a porous matrix the top face of which is covered by a fluid impermeable material with ports aligned with the vortex forming blades.

FIGS. 4A-H illustrate a variety of swirler configurations,

FIG. 5 illustrates the operation of a swirler with a hollow axis.

FIG. 6A-H are cross-section illustrations showing a variety of configurations for disposing swirlers within the matrix of a porous material.

FIGS. 7A and B are cross-section illustrations showing additional varieties of configurations for disposing swirlers within the matrix of a porous material.

FIG. 8 is a cross-section showing two opposing helical swirlers, each having one turn.

FIG. 9A illustrates a plurality of swirler blades incorporated into the face of a fluid-impermeable layer. FIG. 9B is a close-up illustration of a single blade of the configuration shown in FIG. 9A.

FIG. 10 is an exploded view of a fluid enhancement device of the present invention that shows an array of swirler blades, the associated porous matrix, and details of the housing.

### DETAILED DESCRIPTION OF THE PREFERRED EMBODIMENTS

### Term Definitions

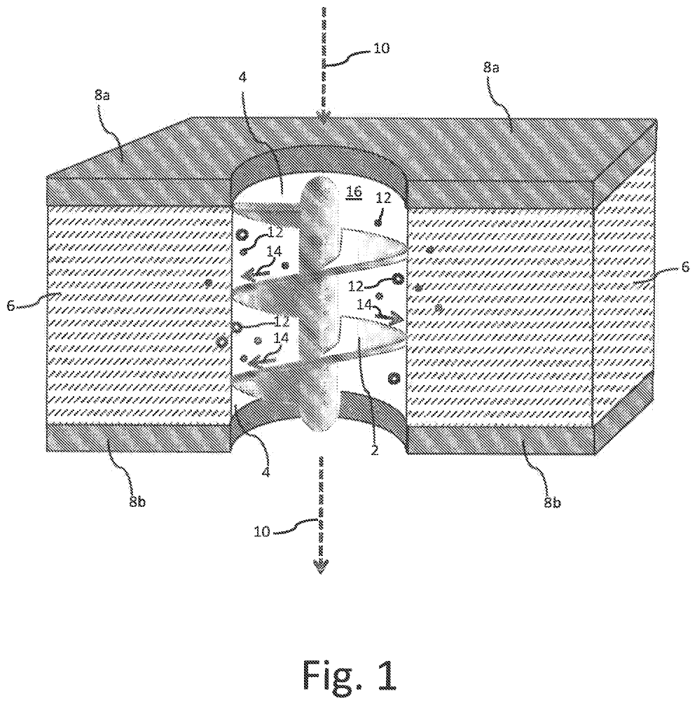

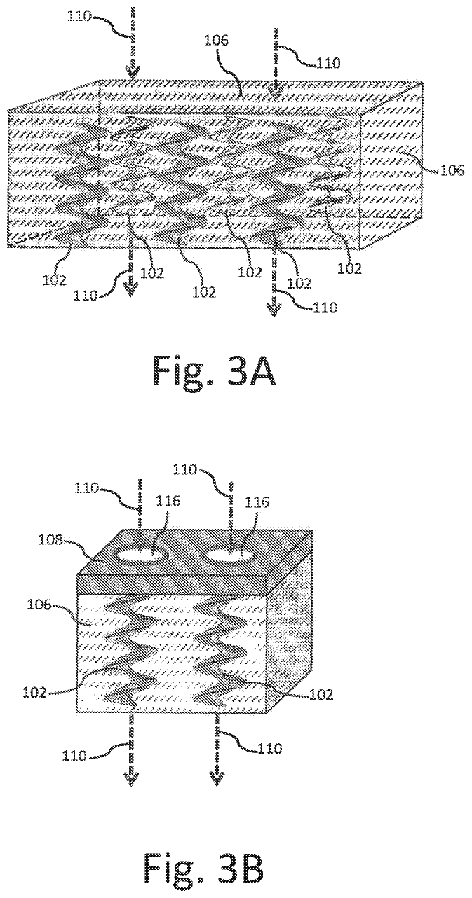

As used hereinbelow, the following terms have the noted definitions:
About: means plus or minus 10% of a given value. Thus, for example, the meaning of the phrase “about 10” means from 9 to 11.
Swirler: means both helical blades or impeller blades, which are necessarily in a fixed or static position, and never move, but impart a swirling motion to a moving fluid stream.
Helical blade: means a blade with a helical surface or a blade having a surface helicity. The helical blade can range in length from a fraction of a turn to multiple turns. It can be continuous over this range or include gaps or discontinuities along this range. It can have a constant pitch, a variable pitch, and a draft angle of zero or greater (i.e., constant or variable, such as a tapered radius).
Impeller blade: means a fixed device shaped to alter the flow and/or pressure of fluids to impart a centrifugal force thereon.
Vortex forming element: means the element or component of the apparatus that generates centrifugal force, and includes helical blades or open impellers. See FIGS. 1 and 3B, for example.
Vortex port: means an opening or an intake egress for the flowing fluid stream to be subjected to the vortex forming elements.
Vortex port array: means an array of vortex ports or intakes for the vortex forming elements, each vortex port containing a vortex forming element in a bore or conduit, See FIG. 1, for example.
Particle: means any solid particle or particulate; but it also means liquid droplets of varying sizes that have chemical and/or physical properties that differ from the fluid containing them. The particles are often of higher density than the fluid of the fluid stream in which they may occur. However, the present invention also comprehends the processing of particles and other substances that have a lower density than the fluid of the fluid stream in which they are contained.
Porous matrix or material: means any material which is absorbent, adsorbent, generally or selectively permeable, and/or functionalized that may have all of these properties within one or more layers. It may be unitary (i.e., a single piece) or granular. It may consist of homogeneous layers or heterogeneous layers, which may even include a mix of unitary layers and granular layers of porous materials. In may also have more than one function. For example, it may be both filter a fluid and provide a desirable substance or substances to the fluid. In this case, two functions can be accomplished with one layer of porous matrix or they can be accomplished by two or more layers. Furthermore, one layer can accomplish one function and another layer can accomplish another function.
Functionalized surface: means a surface that has been modified chemically and/or physically so as to perform a particular desired function. Functions can include, but are not limited to, binding, catalyzing, chemically reacting, capturing, etc. Additionally, functions of the surface can include the ability of the surface to be leached, or extracted from, as in the ability to provide or add one or more substances to a fluid moving therethrough.
Improving the quality of a fluid: means enhancing a fluid by reducing a content of particulate matter in the fluid after passing through the present porous matrix. It may also mean enhancing the content of a fluid by adding substances to the fluid by extraction from a porous matrix or a material associated with a porous matrix, or other means of providing desirable content to the fluid.

Examples of particulate or oily matter so reduced may include silt, oil, chemical pollutants, ions, and pathogenic agents, including bacteria, fungi and/or viruses. Examples of particulate matter that may enhance a fluid may include coffee, tea, pharmaceuticals, fertilizers, mRNA, chemical reactants, etc.

The present invention is an apparatus and method that provides for efficient use of a greater portion of a porous material than is typically used by conventional technology while also lowering resistance to fluid flow. Particles in a flowing stream of fluid, such as water, are separated and removed from the stream by means of centrifugal force and thereby diverted into a porous material in a direction that is generally radial to the axis of fluent flow. Fluid is caused to flow through a vortex port that includes at least one static (i.e., immovable) swirler, which can be a static helical blade or fixed impeller-like device that imparts, by virtue of its structure, a swirling, cyclonic eddy, or vortex movement to the flowing fluid stream. Particles in the fluid can include solid and/or liquid materials. For example, solids can comprise silt particles and liquids can comprise droplets of a wide range of sizes. Given that the particles to be filtered have a different density and/or other physical and/or chemical properties than that of the fluent medium, these particles are urged radially into the porous material to a differing extent than the fluid. This radial and, thus, transverse, direction into the porous material, can increase the mean path length of potential particle movement through the porous matrix resulting in a concomitant increase in the likelihood that a particle will interact with, extract from, or chemically bind to the porous matrix. The present invention is made up of a plurality of vortex ports disposed within a porous material. Should a particle move from a first vortex port through the porous material into a second vortex port, it will be taken up by the second swirling flow or vortex and thus be urged again in a radial or transverse direction into the porous material. Thus, in the present invention, the plurality of swirlers produce a synergistic structure wherein neighboring swirlers cooperate functionally to urge radial or transverse movement of particles within the porous matrix. This increases the likelihood of a physical and/or chemical interaction between particles and the porous matrix. For example, in the case of a filtration device wherein the porous material is a filter matrix, this increases the likelihood that particles will be captured, if not from centrifugal force resulting from a first vortex port, then by the force resulting from a second vortex port.

In one embodiment of the present invention there are no barriers to radial (i.e., transverse from swirlers) movement within the porous material other than the porous material itself. In one version of this embodiment, at least one layer of porous matrix is continuous across its surface area with no discontinuities between swirlers disposed therein. In another version of this embodiment, in at least one layer of the porous matrix, there are discontinuities between the swirlers disposed therein. As one non-limiting example, discontinuities may be fluid-filled spaces.

Although the distance between swirlers can be configured for a wide range of values, the preferred minimal distance between the centers of the central axes of adjacent swirlers is at least three radii (using the largest radius of the swirlers, whether they be of different sizes and/or of variable radial sizes along the swirler's length). The preferred maximum distance between the central axes of adjacent swirlers is no more than eight radii of the largest swirler's radius. However, smaller and larger distances between swirlers are also contemplated and these depend on the particular use of the device and the content of its porous matrix, e.g., its resistance to fluid flow.

Thus, on average, the average particle path is not orthogonal to the device's face but more generally transverse into and through the porous matrix thereby causing a greater chance of interaction with the porous matrix. While the present invention generally contemplates vortex ports that are orthogonal to the apparatus's outer surface, it is also contemplated that vortex ports can be disposed at different angles to the outer surface of the apparatus. It is also contemplated that the present invention can also include vortex ports that are non-linear, for example, vortex ports that are curved. The particles to be removed from the fluid stream have a different density and or different chemical or physical characteristics than the fluid of the fluid stream.

In the present invention, vortices or eddies are formed by the interaction of a fluid, such as water, with swirlers, which are formed from at least one static or fixed helical blade, a static or fixed impeller, a helical tube or space formed within the porous material itself, or a similar fluid-swirling structure that is disposed within the porous material. The axes of the swirlers are generally parallel to the direction of fluid flow. The axes of the swirlers are typically orthogonal to the outer face of the apparatus, but this is not a necessary requirement of the present invention. In the case where the axes of the swirlers are not orthogonal to the outer face of the apparatus, the swirlers will entrain at least a portion of the fluid flow to be parallel to the swirler axes. The swirlers can range in length from a fraction of a turn to a plurality of turns. They can be of constant pitch or variable pitch, and they can have a constant radius or a variable radius. Swirlers can have a central axis from which helical or impeller-like blades extend radially, or the blades can be axis-free with dimensions and a closed or partially closed structure that inhibits all or most axial movement of particles. Swirlers can have a completely closed axis or an axis that is completely or partially open or hollow to allow the least dense material to move through the central axis less impeded by an involute path while denser impurities are urged radially through an involute path into porous material. Swirlers can also have no axis but, instead, an open space with a predetermined radius (either fixed or variable along its length) in place of an axis.

The combination of a swirler and its associated vortex effectively defines an involute path. In some embodiments, the swirler is virtual in that a spiral-shaped tunnel is formed within the porous material, which, because of its shape imparts a centrifugal force upon the fluid flow therein. In this case, the walls of the tunnel are effectively the swirler. Thus, in some embodiments, swirlers are disposed in involute conduits (i.e., spiral-shaped tunnels) formed within the porous material itself. In other embodiments swirlers are disposed directly within the porous material such that there is maximum, contiguous contact between the surface area of the swirler and the porous material, that is, without a conduit parallel to the swirler's axis, formed to contain the swirler. In some embodiments, helical swirlers can have gaps or discontinuities in their blades. It is even contemplated that swirlers per se may comprise twisted strands of fibers directly integrated into, or integral with, a woven or non-woven porous matrix.

The outer faces or surfaces of an apparatus of the present invention need not be planar but, rather, can be shaped hydrodynamically to optimize fluid flow and efficiently urge or funnel fluid flow into vortex ports. Furthermore, outer surfaces of the apparatus of the present invention can be shaped to maximize porous matrix surface area, for example, like an accordion shape.

FIG. 1 is a three-dimensional drawing that illustrates the structure and operation of one vortex port of the present invention. Helical blade 2 is non-moving, i.e., it is static or fixed, and is disposed axially within bore 4. Helical blade 2 and bore 4 together make up vortex port 16. Porous matrix 6 is sandwiched between fluid impermeable layers 8 such that fluid flow into and out of porous matrix 6 can occur only through bore 4. In the embodiment shown in FIG. 1, bore 4 is a conduit through porous matrix 6 and both fluid impermeable layers 8, with a first impermeable layer 8a and a second impermeable layer 8b sandwiching porous matrix 6. Fluid flow direction arrows 10 depict the direction of fluid flow into and out of bore 4. However, as configured in FIG. 1, fluid flow can be bidirectional. As fluid flows through the bore, it is urged into a swirling motion by helical blade 2. This swirling motion imparts on particles contained within the fluid flow a centrifugal force, the direction of which is generally radial and shown by particle direction arrows 14. For the purposes of this invention, the term “particle” comprehends both solid and liquid forms of matter, such as dust, liquid droplets, and aerosols. Under influence of centrifugal forces caused by the swirling motion of the fluid flow, particles 12 are urged against the wall of bore 4 and into porous matrix 6, thereby being separated and removed from the fluid flow. Particles and substances with densities less than that of the flowing fluid, will tend to move toward the central axis of helical blade 2.

The swirling motion of the fluid can extend beyond the end of the helical blade 2 and porous matrix 6 can be dimensioned to extend beyond helical blade 2, as well. Because the centrifugal force urges particles (e.g., impurities) into a radial and, thus, horizontal or transverse motion, a greater path length of movement through the porous matrix is provided. In the case of filtration where the porous matrix is a filter material, this is an improvement over conventional filter technologies wherein particles within a fluid generally move orthogonally to the filter's faces and are thus dispersed through the thinnest dimension of the filter.

In an alternative embodiment, porous matrix 6 can be a material that contains a substance or substances that leach into, or are extracted by, the fluid as it interacts with porous matrix 6. For example, in the case of a coffee machine, the porous matrix is made up of granular coffee particles. Helical blades can be configured to agitate the granular coffee particles within a coffee machine pod thereby causing more efficient extraction of coffee flavor into the fluid (i.e., hot water). This may allow for the use of less coffee per pod and, thereby, be more economical.

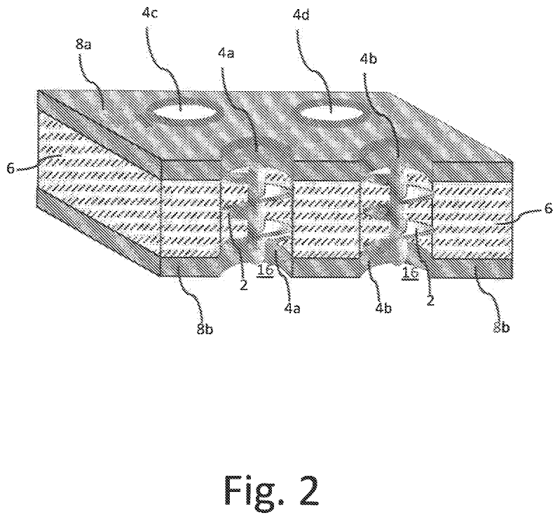

FIG. 2 is a three-dimensional drawing of a two-by-two (2×2) array of vortex ports 16 of the same configuration shown in FIG. 1. Any number of vortex ports 16 are contemplated by the present invention including n×n, n×m (i.e., when vortex ports 16 are arranged linearly, or as a square or rectangle) or any arrangement of vortex ports wherein m is equal to or greater than 1 and n is equal to or greater than 2. Vortex ports 16 of the present invention can be uniformly spaced or non-uniformly spaced. The overall pattern of vortex port 16 arrangement need not be linear or a square, rectangular, or of a regular shape but can be of a variety of shapes (including random or clustered placements) chosen for a particular application. The dimensions of individual vortex ports can be uniform throughout a device or can vary according to their particular location on the apparatus. Furthermore, the present invention does not require that the apparatus structure be generally planar. For example, it can be of an “accordion” or other shape configured to increase surface area and optimize apparatus performance.

FIG. 2 shows 2×2 array of helical ports and a porous matrix configuration of the present invention. As shown in the figure, vortex ports 16 and their associated porous matrix components can comprise a complete configuration per se or they can comprise a portion of a larger porous matrix apparatus. In this figure, helical blades 2 are shown disposed within a cutaway of two vortex ports 16, which are made up of first bore 4a and second bore 4b through first impermeable layers 8a and 8b, which sandwich porous matrix 6. Details within third bore 4c and fourth bore 4d are not shown but they are of the same internal configuration as those of bores 4a and 4b.

FIGS. 3A and 3B show other embodiments of the present invention. In FIG. 3A, helical blades 102 are disposed directly within porous matrix 106. The direction of fluid flow through the porous matrix is generally parallel to the axis of helical blades 102 as shown by arrows 110. In this embodiment, helical blades 102 are embedded intimately within the porous matrix 106 such that the surface area of blades 102 approaches maximum contact with porous matrix 106, and a vortex port and bore are absent. Furthermore, porous matrix is not sandwiched between fluid impermeable layers. Helical blades 102 function to impart a centrifugal force on fluid flowing through the porous matrix and the contents of the fluid. Thus, contents of the fluid that have a different density than the fluid, are more likely to be deflected radially inward or outward and, thus, transversely away from the general direction of fluid flow. Additionally, helical blades 102 tend to increase the average path length of particles through a porous matrix thereby increasing the likelihood of interaction therewith.

FIG. 3B shows a single portion of a porous matrix, which is a variation of the embodiment shown in FIG. 3A. Helical blades 102 are disposed directly within porous matrix 106 similarly to those shown in FIG. 3A. However, for each helical blade (only two are shown) of this embodiment there is an associated port 116 within fluid impermeable layer 108, which serves to direct fluid, flowing generally in the direction of fluid flow direction arrows 110, particularly into the volume of porous matrix 106 occupied by each helical blade 102. In a variation of the embodiment of FIG. 3B (not shown), a second fluid impermeable layer 108 with associated vortex ports 116 are disposed opposite the first vortex ports 116 and first fluid impermeable layer 108 to form a sandwich of porous matrix 106 occupied by helical blades 102. Vortex ports 116 of the second fluid impermeable layer 108 can be coaxial or non-coaxial with (i.e., offset from) the vortex ports 116 of the first fluid impermeable layer 108.

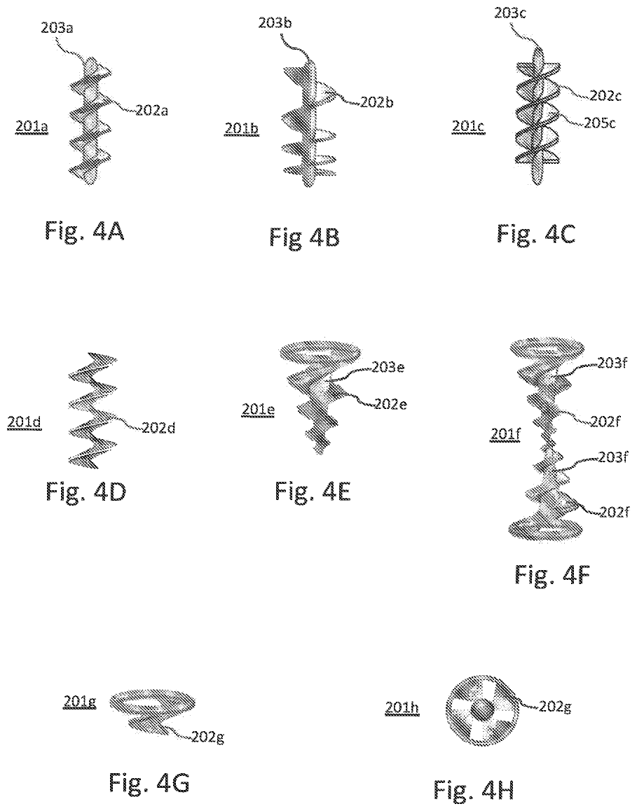

FIGS. 4A-H illustrate various swirler structures useful in the present invention. These are presented by way of example and are in no way meant to be limiting. FIG. 4A shows a swirler 201a with a central axis 203a and a helical blade 202a with a constant pitch and radius disposed around the central axis 203a. A vortex port formed by swirler 201a in combination with a bore would produce a regular and constant dimensioned helical passage between the walls of the bore, axis 203a and helical blade 202a. A variation of this swirler configuration (not shown) is a swirler with a regular helical blade with a constant pitch and radius disposed around the central axis that is tapered along its length.

FIG. 4B shows a swirler 201b with central axis 203b and helical blade 202b with a varying pitch along central axis 203b but with a constant radius. A vortex port formed by swirler 201b in combination with a bore will have a helical passage of changing dimensions formed between and defined by the walls of the bore, axis 203b, and helical blade 202b.

FIG. 4C shows swirler 201c with central axis 203c and first helical blade 202c and second helical blade 205c, wherein first helical blade 202c and second helical blade 205c are intertwined as shown and are 180 degrees out of phase with each other. Thus, the blades of this swirler define two helical passages bounded by the walls of axis 203c, a bore, and first helical blade 202c and second helical blade 205c. There is no limit on the number of blades of a swirler, their pitch or radius dimensions contemplated by the present invention. Thus, FIG. 4C illustrates the use of a plurality of blades without being limiting.

FIG. 4D shows a swirler 201d that lacks a central axis. The dimensions of helical blade 202d are such that there is no space or an extremely small space extending axially along its length. A vortex port formed by swirler 201d in combination with a bore will have a helical passage of constant dimensions.

FIG. 4E shows a swirler 201e with varying radius, central axis 203e, with helical blade 202e that has constant pitch but a varying radius, as shown. Swirler 201e can be used in combination with a bore whose shape varies radially along its length to form a cone or a frustoconical space that accommodates swirler 201e. Alternatively, swirler 201e can be used in combination with a bore that is cylindrical or another shape that does not follow or fit the dimensions of swirler 201e. Helical blade 202e could alternatively have a variable pitch.

FIG. 4F shows swirler 201f whose shape is tapered toward its middle, similar in shape to an hourglass. Thus, central axis 203f and helical blade 202f have a larger radius toward each end of swirler 201f and a smaller radius toward the center of swirler 201f. Helical blade 202f is shown with a constant pitch but could, alternatively, have a variable pitch. Swirler 201f can be used in combination with a bore whose shape varies radially along its length to form an hourglass-shaped space that accommodates swirler 201f. Alternatively, swirler 201f can be used in combination with a bore that is cylindrical or another shape that does not follow or fit the dimensions of swirler 201f.

FIG. 4G shows swirler 201g without a central axis but with helical blade 202g whose length is a single turn. The present invention contemplates helical or other shaped blades whose length can vary between a fraction of a turn to a plurality of turns.

FIG. 4H is a view of swirler 201h with four blades 202g, which, although shaped like a propeller or impeller, like all the blades of the present invention, do not move. Swirlers of the present invention do not have limitations on blade shape other than that they must contribute to and/or cause a swirling motion of fluids to urge particles into and/or through a porous material.

Alternative embodiments not shown in FIGS. 4A-4H include those in which the central axis is removed and replaced by a space with the same shape as the removed axis. A device can have helical swirler blades all of one configuration or a mix of different configurations such as those shown in FIGS. 4A-H, but not be limited thereto. Furthermore, the chirality (i.e., handedness) of a plurality of helical swirler blades can be the same or mixed. That is, in a particular device, the plurality of helical swirler blades can be all right-handed, all left-handed or include both right-handed and left-handed helical swirler blades.

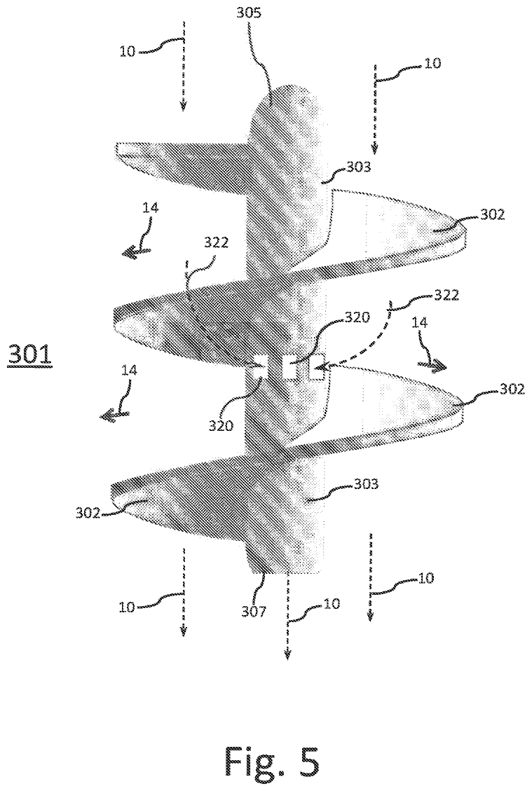

FIG. 5 illustrates the function of an alternative embodiment showing swirler 301 with helical blade 302 and hollow axis 303, with a closed end 305 and an open end 307. Axis 303 can be hollow or partially hollow. Fluid flow direction arrows 310 indicate the direction of fluid flow, which is generally, but not necessarily, parallel to axis 303 of swirler 301. Helical blade 302 of swirler 301 imparts a swirling motion and, thus, a centrifugal force upon the contents of the flowing fluid. Denser components of the flowing fluid tend to move in the direction of particle direction arrows 314. Thus, they are urged outward, away from central axis 303. Less dense components of the flowing fluid, particularly fluid itself, tend to be less affected by the centrifugal force. Fluid nearer to central axis becomes purer. At least a portion of this fluid is able to move into hollow axis 303 through axis ports 320 and out through open end 307. This will tend to decrease total resistance to fluid flow. As an alternative to axis ports 320, hollow axis 303 can be made of a porous material that allows fluid to enter into hollow axis 303. A variation on this embodiment is the use of a helical blade such as helical blade 202d shown in FIG. 4D but with an axial opening or space extending along the length of helical blade 202d.

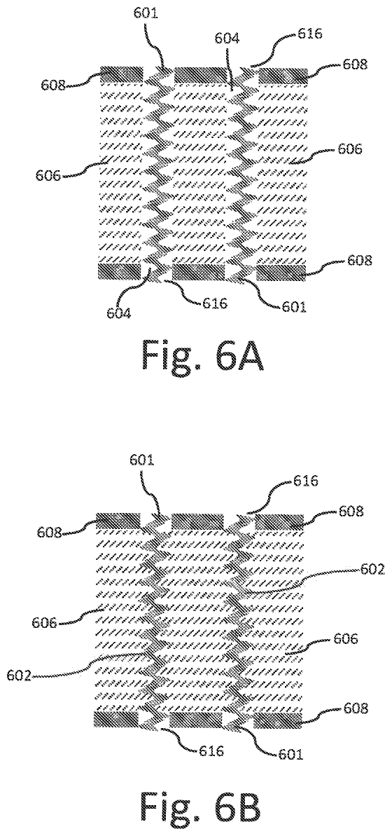

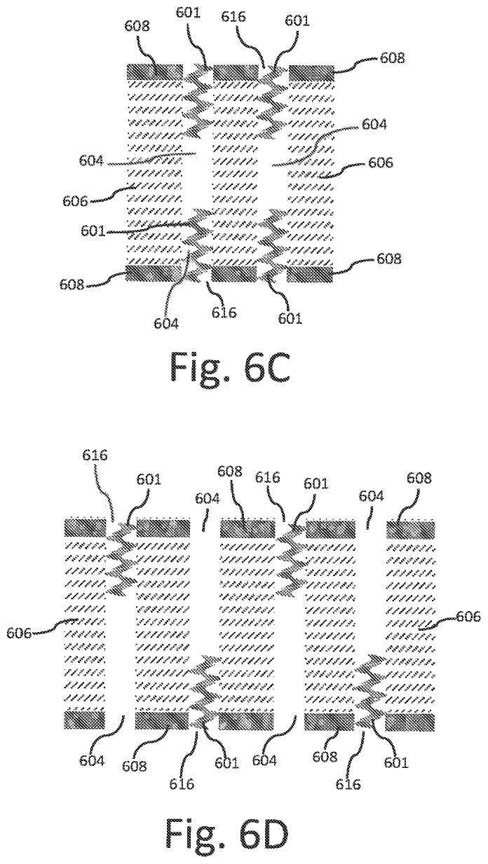

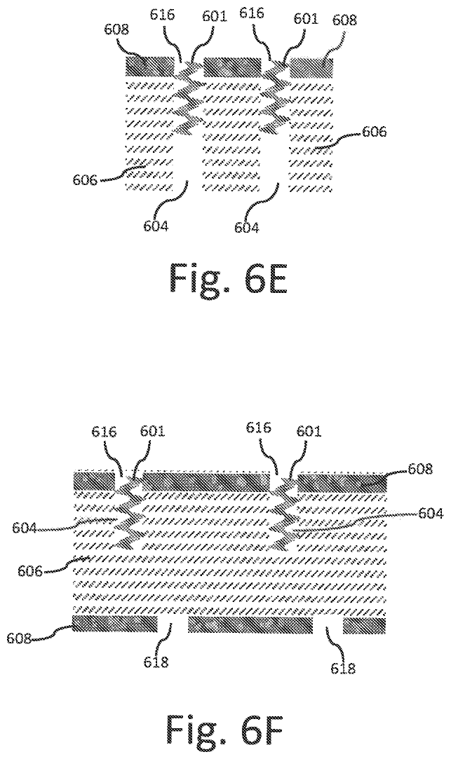

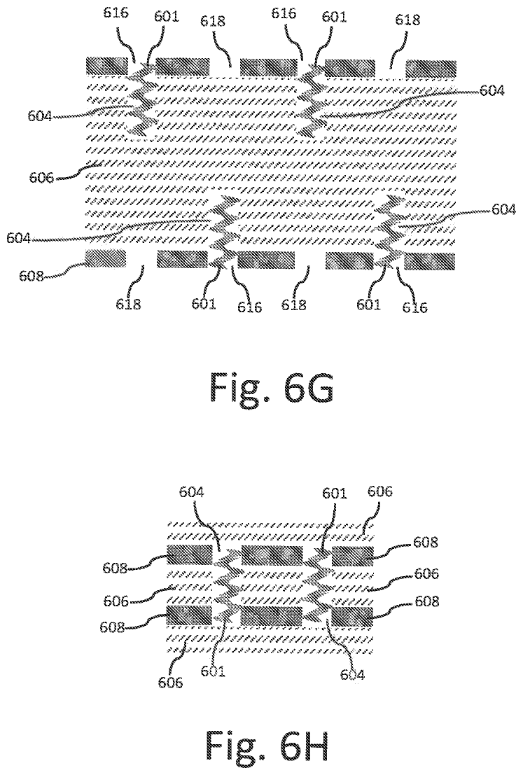

FIGS. 6A-H show a variety of configurations of the present invention. The purpose of each configuration shown is to illustrate the function of a porous matrix structure or to illustrate the function of a portion of a porous matrix structure. For example, any particular configuration may be a part of a more complex porous structure, such as when the configuration shown is just one layer of a multilayered structure that may or may not include additional layers of porous matrix and/or additional layers containing swirlers. These figures are provided by way of illustration and are by no means meant to be limiting. Additional configurations not shown are comprehended by the present invention.

FIG. 6A shows swirlers 601 embedded in porous matrix 606, which is sandwiched between two fluid impermeable layers 608. Swirlers 601 extend through bore 604 completely through porous matrix 606 sandwiched between fluid impermeable layers 608. Vortex port 616 is made up swirler 601 and bore 604, which is a conduit or hole that passes through fluid impermeable layers 608 and porous matrix 606, which is sandwiched between fluid impermeable layers 608.

FIG. 6B is the same configuration as that of FIG. 6A except that there is no bore 604 through porous matrix 606. Instead, helical blades 602 and, thus, the swirler, are disposed directly within, and intimately contiguous with, porous matrix 606. In this configuration, the surface area of helical blades 602 is in direct, maximum contact with the material or materials of porous matrix 606. Every configuration shown in FIGS. 6A-H can also be structured this way, that is, without a bore 604 through porous matrix 606 but, for the purpose of brevity this structure is only shown in FIG. 6B. It should be noted that this general structure is comprehended by FIGS. 3A and 3B.

FIG. 6C shows two pairs of swirlers 601 that partially extend through bore 604 with a space in bore 604 between the opposing ends of each pair of swirlers 601. Each member of each pair of swirlers 601 is coaxial with the other pair member of swirlers 601. Bore 604 is a conduit or hole that passes through fluid impermeable layers 608 and porous matrix 606, which is sandwiched between fluid impermeable layers 608. In this example, vortex port 616 is made up of a pair of swirlers 601 and bore 604.

FIG. 6D shows four vortex ports 616 made up of swirlers 601 extending partially into bores 604 from fluid impermeable layers 608. Swirlers 601 are disposed non-coaxially, alternating their extension into porous matrix 606, one swirler 601 extending from a first fluid impermeable layer 608 and the next swirler 601 extending from an opposing second fluid impermeable layer 608.

FIG. 6E shows two swirlers 601 extending from fluid impermeable layer 608 partially into bores 604, which are conduits through fluid impermeable layer 608 into porous matrix 606. This configuration has only one fluid impermeable layer 608. Vortex ports 616 are made up of swirlers 601 and bore 604 through fluid impermeable layer 608 and porous matrix 606.

FIG. 6F shows two vortex ports 616 made up of swirlers 601 within bores 604 both extending from a first fluid impermeable layer 608 partially into porous matrix 606. Fluid flow ports 618 through a second fluid impermeable layer 608 are non-coaxial with access ports 616, that is, they are offset from the axes of swirlers 601 and bores 604.

FIG. 6G shows four vortex ports 616 made up of swirlers 601 within bores 604 each of swirlers 601 and associated bores 604 extending only partially into porous matrix 606. Swirlers 601 are disposed non-coaxially, alternating their extension into porous matrix 606, one swirler 601 extending from a first fluid impermeable layer 608 and the next swirler 601 extending from a second fluid impermeable layer 608. Associated and coaxial with each swirler 601 is fluid flow port 618 disposed within the opposing fluid impermeable layer 608.

FIG. 6H shows two swirlers within bores 604 both of which extend from a first fluid impermeable layer 608, through a portion of porous matrix 606 to a second fluid impermeable layer 608. Each fluid impermeable layer 608 is covered by a layer of porous matrix 606, which extends beyond the outer surface of each fluid impermeable layer 608.

The present invention comprehends single or multiple layers of the structures shown in FIGS. 6A-G. Multiple layers can be homogeneous in the use of structures in that each layer uses the same configuration or they can be heterogeneous in that different configurations are used in different layers. For example, a configuration can be a structure made up of multiple layers of the same material wherein each layer is a unitary (e.g., single piece) material or a granular substance or substances. Additionally, a configuration can be a structure made up of multiple layers wherein at least one layer is of a unitary material and at least one layer is of a granular substance or substances. It is also contemplated that different configurations can be used in the same layer of a device. Furthermore, the structures shown in FIGS. 6A-H may be sub-components of a device's or apparatus's structure. That is, they may comprise one functioning element of an apparatus made up of multiple functioning elements.

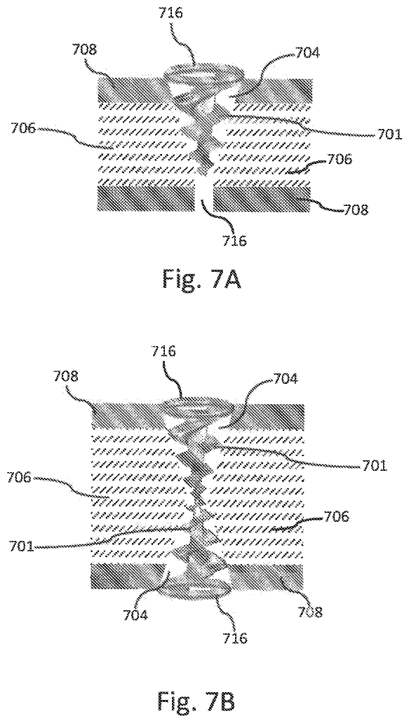

FIGS. 7A and 7B show radially tapered swirlers, each paired with similarly shaped bores. These swirlers correspond, respectively, to those shown in FIGS. 4E and 4F. FIG. 7A shows a swirler 701 whose helical blade and axis taper and extend longitudinally through a similarly shaped bore 704 from a first fluid impermeable layer 708 through porous matrix 706 to a second fluid impermeable layer 708 through which the bore provides an exit from vortex port 716. In an alternative embodiment, bore 704 has a cylindrical shape.

FIG. 7B shows an hourglass-shaped vortex port 716 comprising a swirler 701 with helical blades and axis that taper longitudinally from both ends toward the middle. That is, the radii of swirler 701 helical blades and axis are reduced moving from either end of swirler 701 to the middle of swirler 701. Swirler 701 is within bore 704, which has a similar hourglass shape. Alternatively, swirler 701 can have a bore 704 that is cylindrical (not shown). Vortex port 716 extends from fluid impermeable layers 708 through porous matrix 706.

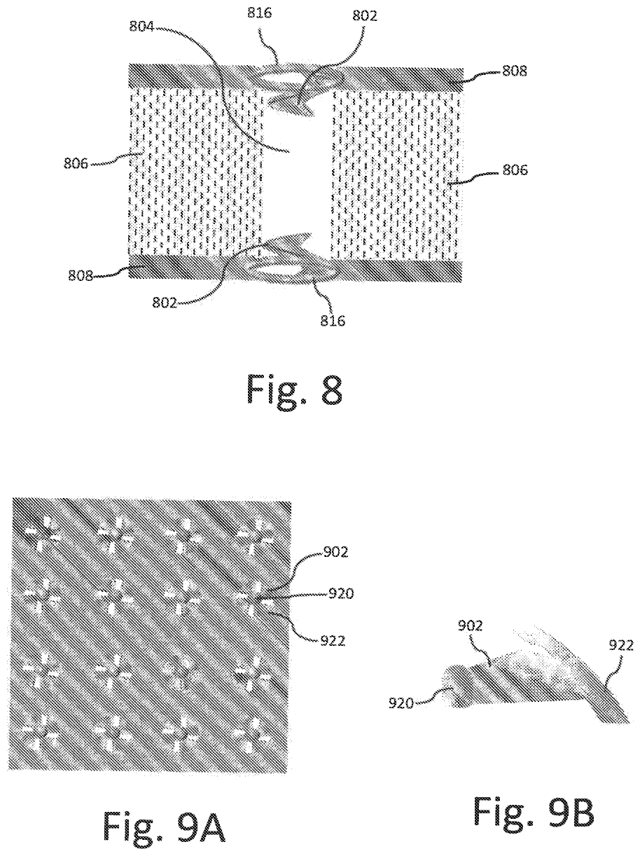

FIG. 8 shows vortex port 816 consisting of a pair of opposing coaxial swirlers extending partially into bore 804, which extends from a first fluid impermeable layer 808 through porous matrix 806 to a second fluid impermeable layer 808. Helical blades 802 are of a single turn and are of the type shown in FIG. 4G.

FIG. 9A shows an array of helical ports each of which consists of four fixed or static blades 902 extending radially from hub 920 to outer ring 922. Blades 902 flare out and are connected to outer ring 922. They are structurally similar to fan or impeller blades except that they are fixed. A single example of this structure is shown in FIG. 4H. FIG. 9B is a more detailed depiction of a single blade portion of the helical ports of FIG. 9A. Blade 902 is shown fixed and extending from hub 920, flaring out toward, and fixed to, outer ring 922.

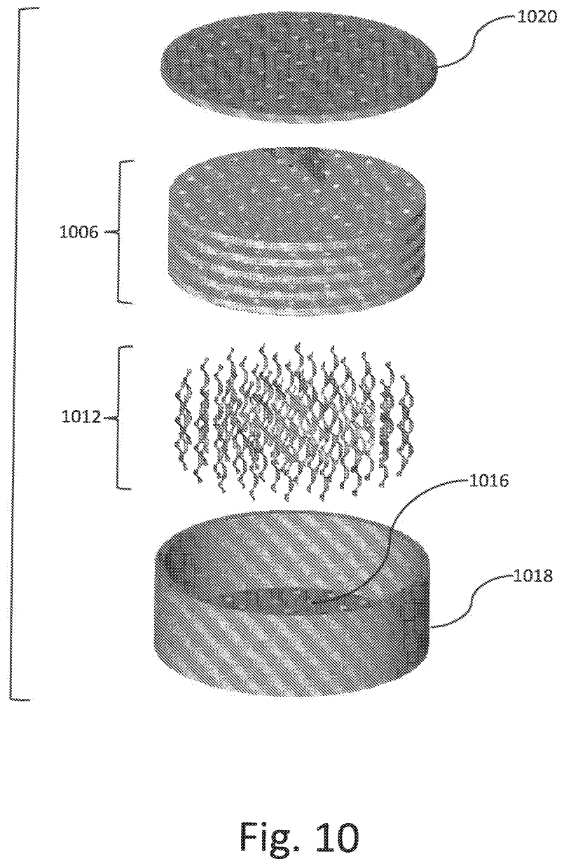

FIG. 10 is an exploded view of one embodiment of the present invention. Helical blade array 1012 is positioned for insertion into porous matrix layers 1006 wherein each helical blade of helical blade array 1012 is coaxial with a vortex port 1016, a plurality of which is disposed in case 1018 and cover plate 1020. In an alternative embodiment not shown, porous matrix layers 1006 can be a single layer or multiple layers of a granular material or materials. In another alternative embodiment, porous matrix layers 1006 can include one or more layers of a granular material and/or one or more layers of a unitary material (e.g., a porous woven or non-woven material, which is often fibrous).

The present invention can be applied to devices that can be washed, de-contaminated, and used multiple times. Devices with insertable porous matrices can be used repeatedly with periodic replacement of the porous matrix. Device materials can be ecologically friendly, i.e., recyclable and/or biodegradable with limited environmental impact.

There is no requirement that vortex ports be of equal dimensions in a particular apparatus. For example, the vortex ports of the device of FIG. 10 may be sized differently at different locations depending on the fluid flow profile. More peripheral vortex ports may have smaller or larger radii as opposed to more central vortex ports, depending on fluid flow velocity and the effects of wall resistance and drag. Generally, vortex ports can be dimensioned according to their location in a device and the fluid flow velocities their particular location is likely to encounter in a given use environment or application.

As a filter embodiment, the present invention optimizes filtration and minimizes fluid flow resistance because fluid passes through comparatively large ports while contaminants are centrifugally removed. This is in contrast to, and an improvement over, conventional fluid filters, which capture particles by limiting permeability to fluid flow thereby causing a high resistance and a slower pass through the filter.

### Porous Matrix Materials

Materials for the present invention can be chosen to enhance performance for particular applications. Materials can include, but not be limited to, metals, synthetic polymers (e.g., plastics), natural polymers (e.g., cellulose), catalysts, biologically active components for binding specific chemical or molecular species (e.g., antibodies, receptors, etc.), biologically active components for causing specific chemical reactions (enzymes), molecular sieves, and others known to those with skill in the art.

A fluid can be enhanced by removing substances therefrom. For example, if a goal is to remove undesirable metal ions from an aqueous fluid, the porous material can be activated charcoal. The aqueous fluid is caused to move in a swirling motion by the swirlers, thereby maintaining the activated charcoal as a slurry and preventing sedimentation, which would tend to inhibit fluid flow. An example of enhancing a fluid by adding a substance thereto is the use of the present invention to brew coffee. Swirlers can be incorporated into coffee pods of a coffee machine or they can be components of the coffee machine itself whereby the swirlers pierce the coffee pod and hot water is introduced through the holes in the pierced pods. Swirling motion of the water will maintain the granular coffee as a slurry and prevent sedimentation. Furthermore, with the present invention, it is likely that a smaller amount of coffee in the coffee pod will be required to yield a satisfactory beverage, thereby saving money.

The chemical and/or physical characteristics of surfaces can be modified by surface modification. When this is done to the surface area of a porous matrix, it can be used in concert with the swirlers of the present invention to enhance a fluid. For example, U.S. Pat. No. 10,155,674, which is incorporated herein by reference in the entirety, discloses a filtration media with functionalized surfaces for the destruction of pathogens and organics. When a filtration media of this type is used as the porous matrix of the present invention, water can be enhanced by the destruction and removal of the captured pathogens and organic molecules or materials. Surface modification is also disclosed in U.S. Pat. No. 9,523,681 (incorporated herein by reference in the entirety), which discloses the immobilization on the surface of a rigid porous matrix a ligand that binds to a protein associated with chromatin, thereby removing and isolating chromatin from a liquid sample. These examples are provided to show the kind of approach one might use to make material choices for constructing the present invention in view of a particular application and are not meant to be limiting in any way.

As another example, the porous matrix or material may be made of a porous nanofiber having a log reduction value greater than about 6. See U.S. Pat. No. 10,252,199, which is incorporated herein in the entirety by reference.

The porous matrix can comprise one or more fibrous materials and/or one or more granular materials. For example, the granular material can be activated carbon or it can contain activated carbon as a component thereof. Zeolites and silica gels are additional examples of porous materials that can be loose. For the purposes of the present invention, granular can also mean forms that are powdered, beaded, or of a variety of mesh sizes of a loose material or substance.

Further, the porous matrix or material may contain a plurality of layers. For example, one layer may contain functional groups to trap viruses or other pathogens. It is known that sulfate and sulfonate functional groups mimic the binding action of sialic acid groups on viruses.

As noted, the present invention may have several distinct layers of the porous material. One layer may contain one or more types of multivalent metal ion, such as multivalent copper, multivalent silver and multivalent zinc. More specifically, the metallic ions are divalent. Another layer may contain sulfate or sulfonate groups, which are known to mimic sialic groups to which many pathogens become bound.

The porous matrix can be made of fibers with different diameters and densities and these different fibers can be disposed as separate adjacent layers such as disclosed in U.S. Pat. No. 10,881,591.

Another example of an anti-microbial and anti-viral material is that of U.S. Pat. No. 7,169,404, which is incorporated herein by reference in the entirety.

In essence, polymeric slurries are prepared containing microscopic particles of water-insoluble ionic copper, which become both encapsulated within the formed polymeric fibers and also exposed on the fiber surfaces. Typically, CuO and Cu₂O are used in a particle size range of 1-10 microns, and in an amount of 0.25 to 10% by weight based on the total polymer weight. The polymers used may be polypropylene, polyamide, or polyester, for example, and may be in the form of a yarn or fiber, for example.

The present invention can incorporate porous non-woven fabrics that comprise or may include electrostatically charged polymers that increase the filtration efficiency of fibrous materials. These may be produced by corona charging, hydrocharging, induction and triboelectrification, etc. U.S. Pat. No. 6,197,709 discloses the use of electrostatically charged, non-woven composites in air filters. WO2019/222668 discloses the hydrocharging of filter media such as polyolefins (e.g., polypropylene) to form electrets thereof. Electroceutical fabrics such as those disclosed in U.S. patent application 2020/0006783 are also contemplated for use as porous materials in the present invention. U.S. Pat. No. 6,197,709, WO2019/222668, and U.S. patent application 2020/0006783 are incorporated herein by reference in the entirety.

These are only a few examples of the chemistry and physics of porous materials that confer the anti-pathogen, anti-pollutant, and/or otherwise fluid enhancing layer or layers that may be used with the present apparatus.

### Optimization

There are several key parameters that someone with ordinary skill in the art will understand related to the optimization of the present invention. Swirler parameters include swirler composition, length, radius, pitch, draft angle, and placement, that is, swirler distribution in a porous matrix and the dimensional separation of swirlers from each other. Porous matrix parameters include composition, number of layers, thickness, volume, porosity/permeability, and specific functional characteristics (e.g., particle capture capacity). The particular pore structure, geometry and how pores are integrated into a porous matrix are also important considerations. Parameters can be scaled to best fit a particular application and the environment of use, which includes the expected fluid flow velocities and accelerations. For example, it is likely that porous materials used in municipal water supply filters will be scaled differently than those designed for laboratory applications.

Optimization of the parameters of an apparatus of the present invention for a particular application can be done empirically.

### Manufacturing Methods

The present invention can be produced in multiple ways. For example, vortex ports and swirlers can be fabricated like grommets or eyelets that have helical blade members extending from their rings, which can be crimped, snap-fitted, or wedged together to hold the vortex ports in place in the material (e.g., plastic or fabric, etc.) of the porous matrix. These can be sharp on their distal ends so as to pierce through the thickness of a porous matrix thereby producing a bore with the swirler disposed through the apparatus.

Alternatively, the present invention can be fabricated by injection molding to produce an array of plastic vortex ports disposed on a first surface extending through holes made in a porous material and having snap fitted connectors coupling to a second surface wherein the porous material is sandwiched between the first and second surfaces. The vortex ports are disposed through the porous material.

Individual helical blades or arrays of helical blades can be fabricated by extrusion or twisting of metal, plastic, or other materials. For example, an extrusion process relevant to the present invention is similar or analogous to the way that spiral forms of pasta are extruded, for example, as disclosed in U.S. Pat. No. 10,117,448 which is incorporated herein by reference in the entirety.

Additive manufacturing, such as 3D printing, can also be used to fabricate the apparatus, including the vortex ports and swirlers. Micromachining and/or photolithography techniques can also be employed to produce dense and extremely small vortex port arrays for the fluid enhancement devices.

The above-described embodiments are not to be construed as limitative, but only intended to be illustrative.

What is claimed is:

1. An apparatus for enhancing the quality of a fluid, comprising
a plurality of vortex forming elements, each comprising:
a) a fixed swirler for imparting a centrifugal force on a moving fluid stream; and
b) a porous matrix, wherein said vortex forming elements are disposed within said porous matrix.

2. The fluid enhancing apparatus of claim 1, wherein said plurality of vortex ports comprise a vortex port array.

3. The fluid enhancing apparatus of claim 1, wherein said fixed swirler in each vortex forming element is a helical blade.

4. The fluid enhancing apparatus of claim 1, wherein said fixed swirler in each vortex forming element is an impeller.

5. The fluid enhancing apparatus of claim 1, wherein said porous matrix comprises one or more layers.

6. The fluid enhancing apparatus of claim 5, wherein said one or more layers of said porous matrix comprise at least one of anti-viral, anti-bacterial, absorbent or adsorbent layers.

7. The fluid enhancing apparatus of claim 1, wherein at least one or more layers of said porous matrix is a filtration material.

8. The fluid enhancing apparatus of claim 1, wherein one or more layers provide at least one substance to said fluid.

9. A method of enhancing the quality of a fluid, which comprises flowing a fluid through the apparatus of claim 1.

10. The method of claim 9, wherein said enhanced quality fluid has a reduced contaminant content.

11. The method of claim 9, wherein said enhanced quality fluid has a reduced particulate or oily content.

12. The method of claim 9, wherein said enhanced quality fluid has at least one added substance wherein said added substance is provided from said porous matrix.

13. The method of claim 11, wherein the reduced particulate or oily matter is silt, oil, chemical pollutants, ions or pathogenic agents.

14. The method of claim 13, wherein said pathogenic agents, are selected from the group consisting of bacteria, fungi or viruses.
